(19) United States
(12) Patent Application Publication
(10) Pub. No.: US 2009/0148571 A1
(43) Pub. Date: Jun. 11, 2009

(54) Disposable spreading device for edible spreadable compounds

(76) Inventor: Ronald F. Reda, Orland Park, IL (US)

Correspondence Address: Ronald F. Reda, 10924 Royal Glen Dr., Orland Park, IL, 60467, US

(21) Appl. No.: 12/315,738

(22) Filed: Dec. 5, 2008

Related U.S. Application Data
(60) Provisional application No. 61/005,624, filed on Dec. 6, 2007.

(51) Int. Cl. B65D 85/00; B29C 45/00; B32B 37/14; A47G 19/30; B65D 85/72

(52) U.S. Cl. 426/115; 156/242; 156/245; 401/195; 53/447; 401/9; 401/52

(57) ABSTRACT

A single use disposable spreading device to be used with pre-attached edible spreadable compounds such as butter, cream cheese, peanut butter and the like. Compounds are attached to spreader and have a protective cover over them to protect them until they are ready to be spread. The device has a snap out handle to grip with fingers for more control when spreading. One or more sides of the device may have a knifelike edge and/or serration to cut food and help spread compounds. The device may be flat or a shape other than flat to conform to the products it is being used on.

This application claims priority to provisional application No. 61/005,624 filed Dec. 6, 2007.

### TECHNICAL FIELD

This invention relates to the field of utensils, and more particularly the spreading of edible compounds such as butter, cream cheese, peanut butter and the like without the use of a secondary utensil such as a knife.

### BACKGROUND OF THE INVENTION

Currently in order to spread an edible compound such as butter or cream cheese one would have to use a secondary utensil such as a knife. Knifes and the edible compounds are not one but separate items and generally the compounds are not meant for singular disposable usage. The problem with this is in the case of carry out food or picnics there may not be a knife or it may have been forgotten in the drive through. There is also a danger for young kids using a knife. Furthermore buttering certain items that are not flat is difficult and messy because the knife is flat. Trying to spread a compound on a round surface is difficult, say for an ear of corn. Spreading butter on corn is very messy and difficult. There is also a lot of wasted butter with this method.

The present invention is provided to solve the problems discussed above and other problems, and to provide advantages and aspects not provided by prior disposable spreading devices for edible spreadable compounds of this type. A full discussion of the features and advantages of the present invention is deferred to the following detailed description, which proceeds with reference to the accompanying drawings.

### SUMMARY OF THE INVENTION

The present invention solves all the problems of the prior method by combining the spreading device with the spreading compound to form a singular disposable device capable of many different spreading compounds and shapes.

In another embodiment the spreading device would have a snap out handle to hold the device and better control the effort of spreading the compound. One would grip the device with their thumb and forefinger. One would then peel off the protective paper to expose the butter. One would now apply the butter to the ear of corn evenly and without a mess, and then dispose of the thin plastic device.

In an embodiment the spreading device is flat. In a flat design it allows for application to a flat surface such as a bagel or toast in which you might apply butter, cream cheese or jelly. This device would be taken from its package and then with ones finger nail snap open the snap out handle. One would now grip the device with their thumb and forefinger. One would then peel off the protective cover to expose the edible spreadable compounds. One would now apply the butter or cream cheese to the bagel evenly and without a mess, and then dispose of the thin plastic device. If desired one could then cut the bagel, bread, pancakes or the like with the knifelike edge.

In an alternate embodiment the spreading device is a shape other than flat and has a curvature meant to conform to an ear of corn or other food and have butter applied to it. This device would be taken from its package and then with ones finger nail snap open the snap out handle.

In an embodiment the spreading device has a knifelike edge.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which;

FIG. 1 is a perspective view of a first embodiment of the invention with a handle in a closed position.

FIG. 2 is a perspective view of the device of FIG. 1 with the handle in an now open position.

FIG. 3 is a perspective view of a second embodiment of the present invention with a handle in a closed position.

FIG. 4 is a perspective view of the device of FIG. 3 with the handle in an open position.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

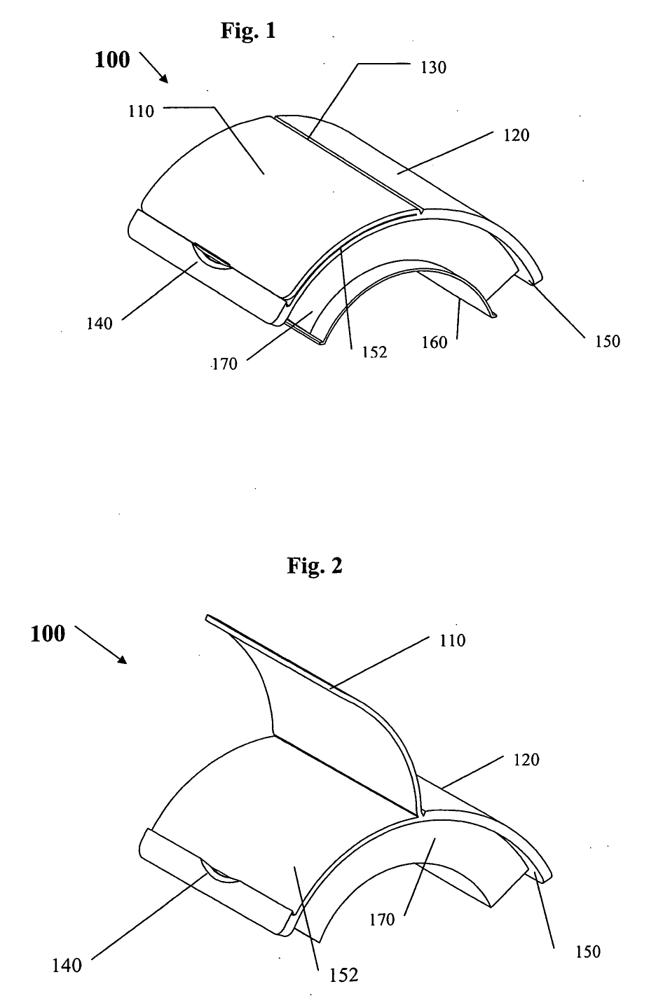

As illustrated in FIG. 1, in one embodiment of the present invention provides an assembly 100 a plastic body 120 possibly injection molded from polypropylene forms the main structural body of the invention. Attached via a living hinge 130 is a snap out handle 110 that clips to an undercut 140 in the body 120 to catch and hold the snap out handle 110 in the down position when it is manufactured and put into its packaging. In an alternative embodiment, the body 120 may be formed from paper or cardboard that is biodegradable. The purpose of the snap out handle 110 to be held in the down position is to allow for a nesting of numerous units 100 to be better orientated in the package to optimize the number of units in a package. For example, if the invention had a stiff fixed handle then many fewer units would fit in a package with the handle being in the open or up position. The first major surface 150 where the edible spreadable compounds 170 are attached may or may not have a surface that is other than smooth to allow for a better bonding of the edible spreadable compounds 170 to the body 120. The assembly 100 provides for the disposable singular use of the device. This invention joins the combination of the spreadable compounds with the spreading device forming in essence a single assembled device. This invention may have numerous shapes to conform to the shape of the item it is applying the edible spread to.

As illustrated in FIG. 2, in accordance with one or more embodiments of the present invention, shows the snap out handle 110 in the open position extending from a second major surface 152; this now allows the grasping by 2 fingers to comfortably and securely spread the edible compound 170 off the body's 120 first major surface 150 and onto the surface of the intended food. Because of its contoured arcuate shape one example of the use for FIG. 2 may be to butter corn. In an embodiment the body 120 may be formed of a flexible material to flex based on the diameter of the corn being buttered. To operate the assembly 100 one would snap out the handle 110, hold it with their fingers, remove the protective paper 160 and then simply rub the butter up and down along the corn. The volume of the compound 170 and corresponding surface area of the first major surface 150 may have a predetermined size so that a single unit 100 is capable of buttering an overage ear of corn.

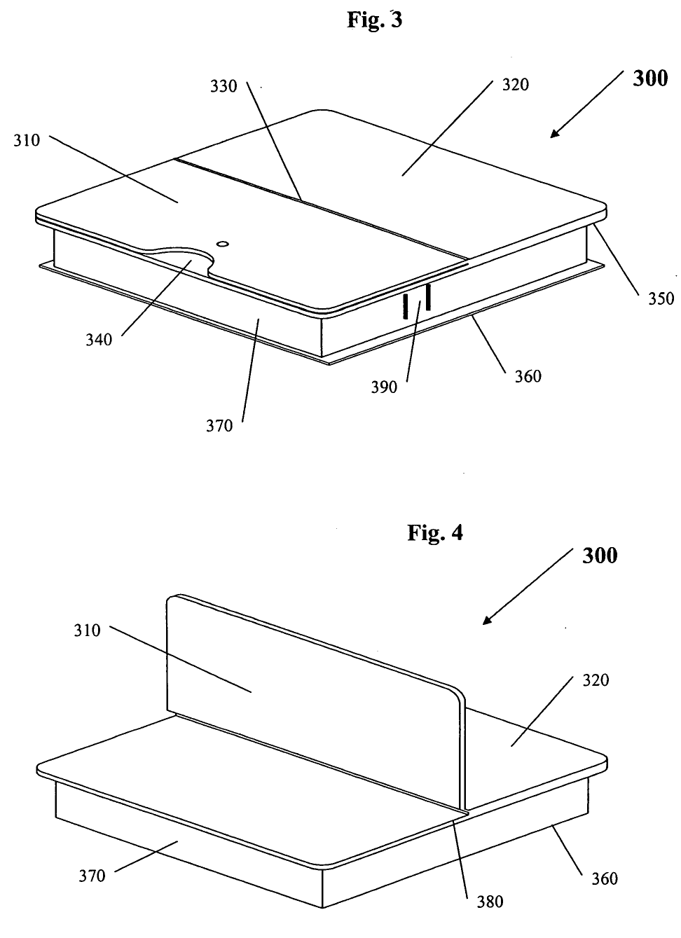

As illustrated in FIG. 3, in accordance with one or more embodiments of the present invention, shows the main structural body 320 in a flat version. Attached via a living hinge 330 is a snap out handle 310 that clips to an undercut 340 in the body 320 to catch and hold the snap out handle 310 in the down position when it is manufactured and put into its packaging. The purpose of the snap out handle 310 to be held in the down position is to allow for a nesting of numerous units to be better orientated in the package to optimize the number of units in a package. The surface 350 where the edible spreadable compounds 370 are attached may or may not have a serrated surface, a retention member 390 or a chemical bonding to allow for a better bonding of the edible spreadable compounds 370 to the body 320. Because of the generally flat shape of the assembly 300 one example of the use for FIG. 3 may be to spread cream cheese on a bagel. In doing so one would snap out the handle 310, hold with their fingers and remove the protective paper 360 then simply spread the cream cheese on the bagel without the use of a knife. Other spreadable compounds may include syrup, wax, candy, powdered sugar, syrup, toothpaste, medicinal creams, grease, oil, rosin, gum, balm, polish or ice.

As illustrated in FIG. 4, in accordance with one or more embodiments of the present invention, shows the body 320 in a flat version with the snap out handle 310 in the open up position. Because of its flat shape one example of the use for FIG. 4 may be to spread cream cheese 370 or butter on a bagel or toast. In doing so one would snap out the handle 310, hold it with their thumb and forefinger and with their other hand remove the protective paper 360 and then simply apply the cream cheese 370 or butter on the bagel or toast.

As illustrated in FIG. 4, in accordance with one or more embodiments of the present invention, shows the body 320 having a knifelike edge 380 to aid in the spreading of the compounds or to cut through the toast or bagel. In such an embodiment, the body structure 320 is rigid and is preferably formed of a polymer material such as High Density Polyethylene.

In accordance with one or more embodiments of the present invention, the spreadable compound 370 has a protective paper sheet 360 to protect the compound from prematurely touching another surface.

In accordance with one or more embodiments of the present invention, an edible spreadable compound 370 is pre-attached to the structure body 320, this compound may include any spreadable edible compound to be applied to another surface. In an embodiment the assembly 300 may be manufactured according to the following steps:

a) The structure body would be formed utilizing an injection molding process including a handle attached via a living hinge.
b) The structure body would then be joined together with the spreadable edible compound in a variety of ways depending on the spreadable compound. One method might be to have a textured surface on the first major surface that would create more surface tension allowing the spreadable compound to adhere better, a second method might be to have a retention member 390 such as one or more than one rib forming a pattern within the spreadable compound area attached to the structured body, these ribs would be small and soft to flex and fold at 90 degrees with the compound as it is being spread to another surface allowing all the compound to be accessed from the first major surface. Still a third method might be a chemical bond between the spreadable compound and the first major surface. The spreadable compound would be of a pre-determined amount to be applied to a certain surface of say an ear of corn.
c) The structured body along with the bonded spreadable compound now attached to it would now have the protective sheet applied to protect it from inadvertent contact with another object. The protective sheet may be adhered using the stickiness of the spreadable compound itself. Where the spreadable compound is not sticky, other methods such as adhesives or additional layers of sticky (edible) compounds may be used to attach the protective sheet.
d) The last step would be to take the assembled structured body and now place it in a package with more than one of the same.

While the specific embodiments have been illustrated and described, numerous modifications come to mind without significantly departing from the spirit of the invention and the scope of protection is only limited by the scope of the accompanying Claims.

What is claimed is:

1. A spreading device comprising:
a structural body having a first and second major surface, the first major surface having a spreadable compound attached thereto.
the second major surface having a handle attached thereto to provide a single use disposable spreading device.

2. The spreading device according to claim 1 wherein:
said body being substantially an arcuate shape.

3. The spreading device according to claim 1 wherein:
said body being substantially flat.

4. The spreading device according to claim 1 further comprising:
a snap out collapsible handle having a integral hinge to pivot to an open position for holding device with fingers.

5. The spreading device according to claim 1 further comprising:
a protective sheet to protect the spreadable compound from pre-maturely coming in contact with another surface.

6. The spreading device according to claim 1 further comprising:
said body has a knifelike edge to aid in the spreading of the compounds or the cutting of foods.

7. The spreading device of claim 1 wherein the first major surface is on a side of the body opposite the second major surface.

8. The spreading device of claim 1 wherein the spreadable compound is edible.

9. The spreading device of claim 1 wherein the first major surface includes a plurality of retention members for retaining the spreadable compound thereto.

10. A method of assembling a spreading device comprising the steps of:
providing a structural body;
adhering a spreadable compound to the body; and
covering the spreadable compound with a protective sheet.

11. The method of claim 10 wherein a predetermined volume of the spreadable compound is measured and dispensed onto the body.

12. The method of claim 10 further comprising the step of injection molding the structural body from a polymer material.

13. The method of claim 10 further comprising the step of forming a plurality retention members on the body.

14. The method of claim 10 further comprising the step of forming a handle on the body.

15. The method of claim 14 further comprising the step of arranging the handle in a closed position and stacking multiple spreading devices in a package so that the multiple spreading devices are closely arranged with the package.
